(19) United States
(12) Patent Application Publication
(10) Pub. No.: US 2022/0388651 A1
(43) Pub. Date: Dec. 8, 2022

(54) AN ARM MECHANISM FOR DOCKING AN UNMANNED AERIAL VEHICLE TO A STRUCTURE FOR NON-DESTRUCTIVE TESTING

(71) Applicant: Detect Technologies Private Limited, Chennai (IN)

(72) Inventors: Karthik Rajasekaran, Chennai (IN); Karthik Rajasekaran, Chennai (IN); Mohan Kumar, Chennai (IN); Pavantanooj Kodari Sai, Chennai (IN); Sunil Gd, Chennai (IN); Abhiman Sarkar, Chennai (IN); Kaushik Sampath, Chennai (IN); Raakesh Kamal, Chennai (IN)

(21) Appl. No.: 17/629,704

(22) PCT Filed: Jul. 23, 2020
(86) PCT No.: PCT/IB2020/056941

§ 371 Date: Jan. 24, 2022

(30) Foreign Application Priority Data
Jul. 24, 2019 (IN) 201941029898

(51) Int. Cl. B64C 39/02

(52) U.S. Cl. CPC B64C 39/024; B64C 2201/027; B64C 2201/12

(57) ABSTRACT

The present disclosure discloses an arm mechanism (100) for docking an unmanned aerial vehicle (200), to a structure for conducting non-destructive testing. The arm mechanism (100) comprises a bracket (101), which is connected to a body (201) of the unmanned aerial vehicle (200). Further, the arm mechanism (100) comprises a pair of members (M) positioned in the bracket (101), and each of the pair of members (M) are configured to rotate relative to movement of a driving unit (D). Furthermore, the arm mechanism (100) comprises at least one arm (104), which is coupled to each of the pair of members (M). Actuation of the driving unit (D), drives each of the pair of members (M) to angularly displace each of the at least one arm (104), to facilitate adjustment of arms (104) for docking the unmanned aerial vehicle (200) to different geometrical structures for conducting non-destructive testing.

### TECHNICAL FIELD

Present disclosure generally relates to a field of aerial vehicles. Particularly, but not exclusively the present disclosure relates to an unmanned aerial vehicle. Further embodiments of the present disclosure discloses an arm mechanism for docking the unmanned aerial vehicle to a structure for conducting non-destructive testing.

### BACKGROUND OF DISCLOSURE

Large scale infrastructures such as refineries, tall chimneys, storage tanks and the like used in manufacturing set-ups and industries, operate at harsh environmental conditions. This demands for regular inspection and maintenance of structural strength, in order to ensure safety of the operators, by averting any disaster. Generally, contact inspection technique is adapted to assess inspection parameters such as thickness and structural damages such as cracks, deformation, mass-formation and the like, which depict conditions of the structure. Conventionally, contact inspection technique is performed manually i.e. by technicians, who access specific inspection points using man lifts, cranes, scaffoldings, rope access techniques and the like. Adapting these techniques to access inspection points are expensive and may pose various work hazards to the technicians. Further, manual contact inspection of these assets is cumbersome, due to enormous height and size of the structures. Also, the harsh operating conditions of these structures hinders the operator from assessing all the inspection points. These factors may create a scope for errors in the manual inspection, which leads to inaccuracy and delayed inspection results, which is undesired.

Considering the above, and with the advent of technology, wheeled robots or crawler robots are adapted to inspect such structures. The wheeled robots or the crawler robots may be configured to displace on an outer or inner surface of the structure, to assess various parameters such as thickness, detection of cracks and the like. However, application of wheeled robots or crawler robots are limited to ferromagnetic structures and moreover cannot be used to access some locations at higher heights.

Several attempts have been made in the art to mitigate the problems associated with inappropriate methods of assessing the structures. One such development is use of an unmanned aerial vehicle to conduct contact testing (Ultrasonic testing) for some of the structures mentioned above. However, presently the use of unmanned aerial vehicles is limited from being used in extreme harsh environments i.e. very high temperatures of above 150 to 200 degree Celsius of the assets. Further, the application of the existing unmanned aerial vehicle is limited to one type of geometrical structure i.e. one unmanned aerial vehicle is used only for a specific geometrical structure. For a structure with different geometrical structure, the unmanned aerial vehicle demands for either replacing the docking mechanism (i.e. docking arms) or demands for using a new unmanned aerial vehicle, based on the geometry of the structure to be analyzed.

The present disclosure is directed to overcome one or more limitations stated above.

### SUMMARY

One or more shortcomings of the conventional unmanned aerial vehicle used to conduct non-destructive testing are overcome and additional advantages are provided through the present disclosure. Additional features and advantages are realized through the techniques of the present disclosure. Other embodiments and aspects of the disclosure are described in detail herein and are considered a part of the claimed disclosure.

In a non-limiting embodiment of the disclosure, an arm mechanism for docking an unmanned aerial vehicle to a structure for conducting non-destructive testing, is disclosed. The arm mechanism includes a bracket, which is connectable to a body of the unmanned aerial vehicle. Further, the arm mechanism comprises a pair of members rotatably positioned in the bracket, where each of the pair of members are configured to rotate relative to movement of a driving unit. Additionally, the arm mechanism comprises at least one arm, coupled to each of the pair of members. Actuation of the driving unit, drives each of the pair of members to angularly displace each of the at least one arm, to facilitate adjustment of the arms for docking the unmanned aerial vehicle to the structure for conducting non-destructive testing.

In an embodiment, each of the pair of members is a gear, and the gear is a spur gear.

In an embodiment, the driving unit is a worm gear, and is positioned in meshing engagement between the pair of gears. In an embodiment, angular displacement of each of the at least one arm, facilitates in docking the unmanned aerial vehicle to different geometries of the structure.

In an embodiment, the driving unit is actuatable by a flange shaft, wherein the flange shaft is removably connectable to the driving unit.

In an embodiment, a wheel is coupled to an end of each of the at least one arm, to facilitate docking and travel of the unmanned aerial vehicle.

In an embodiment, the arm mechanism is enclosed in a housing made of thermally insulative material. The thermally insulative material is one of a ceramic and a carbon material.

In an embodiment, the pair of members is a coupler unit.

In an embodiment, the driving unit is a collar, configured to displace on a sleeve member.

In an embodiment, the arm mechanism comprises a pair of link members, configured to connect the collar and each of the pair of arms.

In another non-limiting embodiment, an unmanned aerial vehicle adapted for conducting non-destructive testing is disclosed. The aerial vehicle comprises a body, a plurality of rotors supported by the body. The plurality of rotors is adapted to exert a propulsion force to the unmanned aerial vehicle. Further, aerial vehicle comprises a support structure connected to the body, wherein the support structure is configured to position a testing probe. Additionally, the aerial vehicle comprises an arm mechanism, for docking the unmanned aerial vehicle to a structure. The arm mechanism comprises a bracket, connectable to a body of the unmanned aerial vehicle. Further, the arm mechanism comprises a pair of members rotatably positioned in the bracket, wherein each of the pair of members are configured to rotate relative to movement of a driving unit. Additionally, the arm mechanism comprises at least one arm, coupled to each of the pair of members. Actuation of the driving unit, drives each of the pair of members to angularly displace each of the at least one arm, to facilitate adjustment of the arms for docking the unmanned aerial vehicle to the structure for non-destructive testing.

In an embodiment, center of gravity of the unmanned aerial vehicle is between a center of geometry of the body and the probe, to facilitate in docking the unmanned aerial vehicle to the structure.

In an embodiment, the support structure includes a telescopic arm, configured to adjust the testing probe based on angular displacement of each of the at least one arms.

In an embodiment, the support structure of the testing probe comprises an adjustment mechanism to angularly displace the testing probe.

In an embodiment, the adjustment mechanism includes a spur gear and worm gear arrangement, to angularly displace the testing probe.

In an embodiment, the adjustment mechanism includes a rosette gear arrangement.

In an embodiment, the testing probe is an ultrasonic probe, and is encased with ceramic material to withstand high temperature.

In an embodiment, at least one sensor associated with the testing probe, wherein the at least one sensor is configured to determine contact of the testing probe with a surface of the structure.

In an embodiment, the at least one sensor is a force sensor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING FIGURES

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 illustrates a perspective view of an unmanned aerial vehicle employed for conducting non-destructive testing of a structure, in accordance with an embodiment of the present disclosure.

FIG. 2 illustrates a perspective view of an arm mechanism for docking the unmanned aerial vehicle of FIG. 1 to the structure, in accordance to some embodiments of the present disclosure.

FIG. 3 illustrates magnified view of portion ‘A’ of the arm mechanism of FIG. 2.

FIG. 4 illustrates a perspective view of the unmanned aerial vehicle, in accordance with another embodiment of the present disclosure.

FIG. 5 illustrates of the arm mechanism for docking the unmanned aerial vehicle, in accordance with another embodiment of the present disclosure.

FIG. 6 illustrates a perspective view of an adjustment mechanism for a probe holder of the unmanned aerial vehicle of FIG. 1, in accordance with some embodiments of the present disclosure.

FIG. 7 illustrates a perspective view of the testing probe, in accordance to an embodiment of the present disclosure.

FIGS. 8A and 8B illustrates a perspective view and an exploded view of the adjustment mechanism of the probe holder, respectively in accordance with another embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that mechanism or system that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Embodiments of the present disclosure discloses an arm mechanism for an unmanned aerial vehicle, for non-destructive testing such as an ultrasonic testing. The arm mechanism comprises a bracket, a pair of members positioned in the bracket and a driving unit. Each of the pair of members is configured to rotate relative to movement of the driving unit. Further, the arm mechanism comprises at least one arm coupled to each of the pair of members. In an embodiment, actuating the driving unit, drives (thus, rotates) each of the pair of members. This rotation of each of the pair of members, may result in angular displacement of each of the at least one arm. This angular displacement of each of the at least one arm, based on the requirement provides flexibility for the unmanned aerial vehicle to dock itself on to the structure having different geometrical structures and different geometrical structures.

In the following detailed description, embodiments of the disclosure are explained with reference of accompanying figures that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

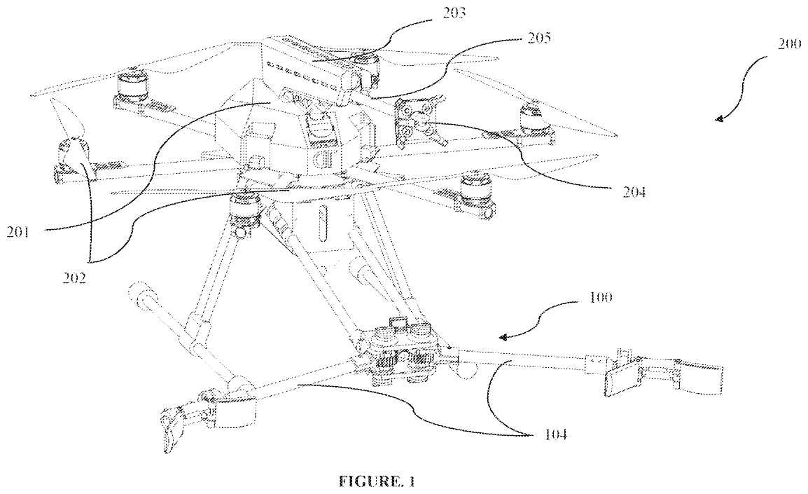

FIG. 1 illustrates a perspective view of an unmanned aerial vehicle (200) (hereinafter referred to as aerial vehicle), in accordance with some embodiments of the present disclosure. The aerial vehicle (200) may be adapted for conducting non-destructive testing (NDT), such as but not limiting to ultrasonic testing for a structure. In an embodiment, the structures may be but not limiting to chimneys, storage tanks, vessels and the like in the industries.

As shown in FIG. 1, the aerial vehicle (200) may broadly comprise of a body (201), and a plurality of rotors (202) supported by the body (201). In an embodiment, the plurality of rotors (202) are adapted to exert a propulsion force, for generating lift and maneuvering the aerial vehicle (200). Further, the aerial vehicle (200) may comprise of a support structure (203) connected to the body (201). The support structure (203) may support a probe holder (205), which may be configured to accommodate a testing probe (204). As an example, the testing probe (204) may be, but not limiting to an Ultrasonic test [UT] probe for conducting ultrasonic testing, in order to determine thickness, cracks and other parameters of a structure. Furthermore, the aerial vehicle (200) comprises an arm mechanism (100) including at least a pair of arms (104), which may be configured to facilitate docking of the aerial vehicle (200) on to a surface of the structure. Once the aerial vehicle (200) is docked on to the structure, the testing probe (204) may come in contact with a surface of the structure for conducting non-destructive testing. In an embodiment, once the testing probe (204) (thus, the UT probe) comes in contact with the surface of the structure, the testing probe (204) may be held stationary for a few seconds (e.g. 1 to 2 seconds) for obtaining measurements. The testing probe (204) may induce a normal beam i.e. an ultrasonic signal that travels through the surface and subsurface and gets reflected. The reflected signal from the back surface is detected by the probe and is converted to a digital reading of the parameter such as thickness, crack depth and like of a portion of the structure underneath the probe. Additionally, the aerial vehicle (200) comprises, an arm mechanism (100). The arm mechanism (100) may be adapted to adjust each of the pair of arms (104) to facilitate the aerial vehicle (200) to dock on to different geometrical structures, without limiting the scope of the aerial vehicle (200) to a specific geometrical structure. Further, center of gravity of the aerial vehicle (200) is between a center of geometry of the body (201) and the testing probe (204). This feature also aid in effective docking the aerial vehicle (200) to the structure.

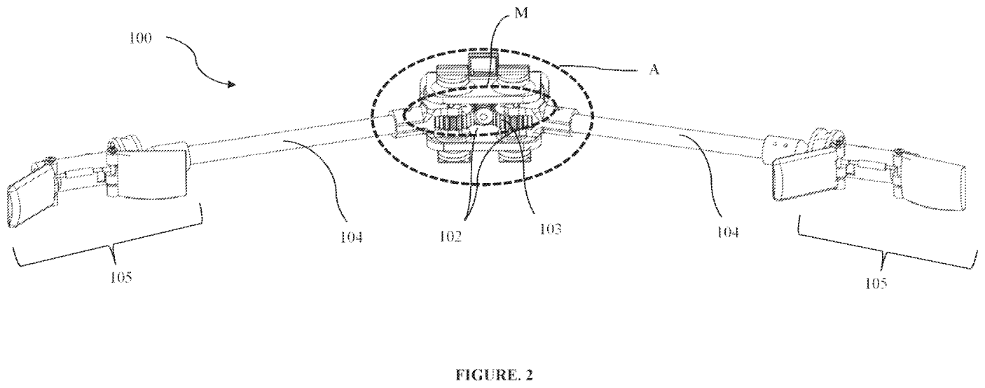

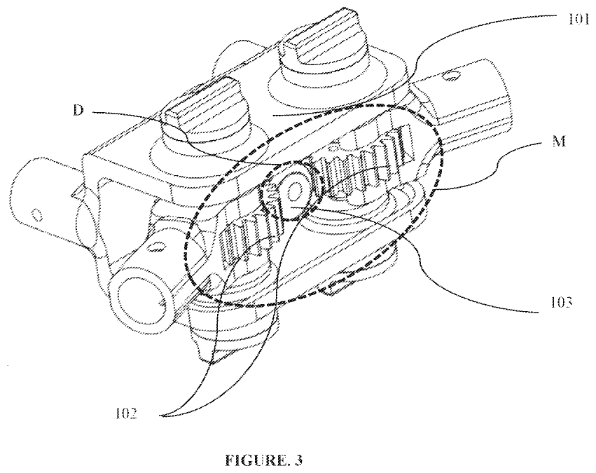

FIGS. 2 and 3, illustrates a perspective view of the arm mechanism (100), in accordance to an embodiment of the present disclosure.

As illustrated in FIGS. 2 and 3, the arm mechanism (100) may comprise a bracket (101). The bracket (101) may be connectable to the body (201) of the aerial vehicle (200). As an example, the bracket (101) may be connected to the body (201) using suitable mounting members, such as but not limiting to sleeve members. In an embodiment, the bracket (101) may be configured to support a number of components of the arm mechanism (100). Further, the arm mechanism (100) may comprise a pair of members (M), which may be rotatably positioned in the bracket (101). In an illustrative embodiment, each of the pair of members (M) may be pair of gears (102). As an example, each of the pair of gears (102) may be rotatably positioned in the bracket (101) using suitable bearing arrangement. Further, each of the pair of gears (102) are configured to be operated (thus, rotated) by a driving unit (D). In an embodiment, the driving unit (D) may be a worm gear (103). The worm gear (103) may be operatively positioned between the pair of gears (102) in a meshing engagement with each of the pair of gears (102) in the bracket (101). Each of the pair of gears (102) may be configured to rotate relative to the movement of the worm gear (103). Additionally, the arm mechanism (100) may comprise at least one arm (104), coupled to each of the pair of gears (102), via suitable fastening means. In an embodiment, the arm (104) may be detachably coupled to each of the pair of gears (102), to facilitate ease in packaging and transportation of the aerial vehicle (200).

In an embodiment, positioning the driving unit (D) (thus, the worm gear (103)) between the pair of gears (102) may not be construed as a limitation, as individual driving unit (D) may be adapted to rotate each of the pair of gears (102) independently, without deviating from the scope of the present disclosure.

Further referring to FIGS. 2 and 3, the driving unit (D) may be configured to be operated manually via a flange shaft (not shown in figures), by an operator or may be automated using suitable actuation means such as stepper motors and the like.

By actuating the driving unit (D) via the flange shaft, each of the pair of gears (102) are operated (thus, rotated). Rotation of each of the pair of gears (102), may facilitate in angular displacement of each of the at least one arm (104) towards and away from each other. As an example, actuating the driving unit (D) in a first direction, say clockwise direction, one of the pair of gears (102) may rotate in a first direction, i.e. clockwise direction, while one of the pair of gears (102) may rotate in a second direction say anti-clockwise direction. This movement of each of the pair of gears (102), angularly displaces each of the at least one arm (104) away from each other. In other words, this rotation of the each of the pair of gears (102), facilitates in diverging each of the at least one arm (104). Further, actuating the driving unit (D) in a second direction, say anti-clockwise direction, one gear of the pair of gears (102) may rotate in anti-clockwise direction, while the other gear of the pair of gears (102) may rotate in clockwise direction. This movement of each of the pair of gears (102) may angularly displace each of the pair of gears (102), towards each other. In other words, this rotation of each of the pair of gears (102), facilitates in converging each of the at least one arm (104). This angular displacement of the each of the at least one arm (104), between a predefined position, may facilitate in docking the aerial vehicle (200) to different geometrical structures, for conducting non-destructive testing.

In an embodiment, diverging the at least one arms (104) due to actuation of the driving unit (D) in clockwise direction, and converging the at least one arms (104) due to actuation of the driving unit (D) in anti-clockwise direction may not be construed as a limitation, since clockwise actuation of the driving unit (D) may result in converging of the at least one arm (104) and anti-clockwise actuation of the driving unit (D) may result in diverging of the at least one arm (104), without deviating from scope of the present disclosure.

As apparent from FIG. 2, an end of each of the at least one arms (104) comprises a pad (105). The pad (105) may be coupled to the end of the at least one arms (104) via a torsional spring (not shown in figures). As an example, the pad (105) may be made of polymeric material, such as but not limiting to rubber material. In an embodiment, the pad (105) may help in providing necessary traction for firm docking of the aerial vehicle (200) on to the structure.

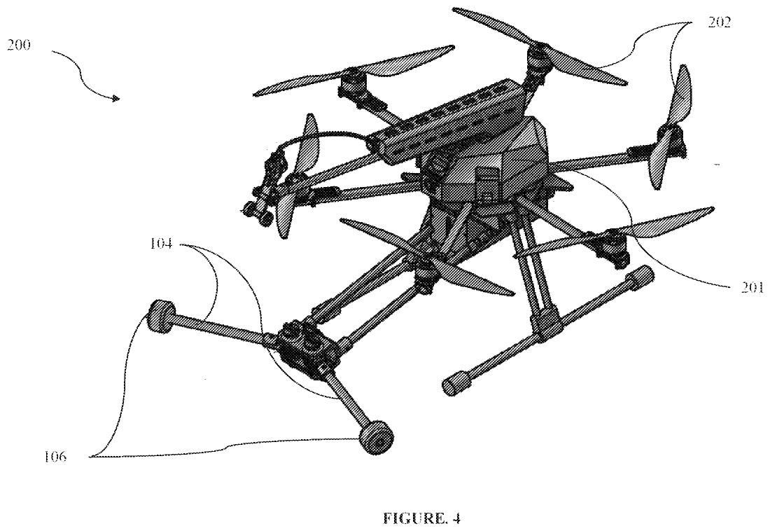

Referring to FIG. 4, which illustrates the unmanned aerial vehicle (200), in accordance to another embodiment of the present disclosure. As apparent from FIG. 4, an end of each of the at least one arm (104) may comprise a wheel (106). The wheel (106), may be configured to facilitate necessary traction for docking the aerial vehicle (200) on to a structure and also assists in linear travel of aerial vehicle (200) on a surface of the structure on which the aerial vehicle (200) is docked. In an embodiment, the wheel (106) may be supported at the end of each of the at least one arm (104) by suitable bearing.

In an embodiment, the driving unit (D) may be actuated to angularly adjust each of the at least one arm (104) based on the geometry of the structure to be docked, before flight of the aerial vehicle (200) or the driving unit (D) may be operated to adjust each of the at least one arms (104) during on-board of the aerial vehicle (200), in order to dock the aerial vehicle (200) to different geometrical structures.

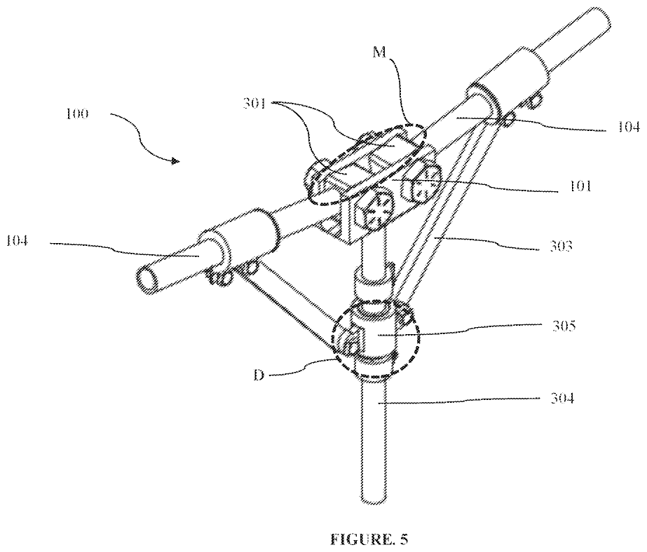

FIG. 5 illustrates a perspective view of the arm mechanism (100), in accordance to another embodiment of the present disclosure.

In the illustrated embodiment, the pair of members (M) in the arm mechanism (100) may be coupler units (301), which may be rotatably positioned in the bracket (101). As an example, each of the pair of coupler units (301) may be rotatably positioned in the bracket (101) using suitable bearing arrangement. Further, each of the pair of coupler units (301) are configured to be operated (thus, rotated) by a driving unit (D). In an embodiment, the driving unit (D) may be a collar (305) disposed on a sleeve member (304), and is configured to displace in an upward and downward direction on the sleeve member (304), within a predefined length. Furthermore, the arm mechanism (100) may include at least one arm (104), coupled to each of the pair of coupler units (301). Additionally, the arm mechanism (100) comprises a pair of link members (303), which may be configured to connect each of the pair of arms (104) and the collar (305).

In an embodiment, displacing the collar (305) on the sleeve member (304) in an upward direction, may facilitate in angularly displacing each of the pair of arms (104) towards each other. In other words, displacing the collar (305) in the upward direction, facilitates each of the link members (303) to pivot towards the bracket (101). This facilitates in angularly displacing the each of the pair of arms (104) towards each other i.e. converging each of the pair of arms (104). Further, displacing the collar (305) in a downward direction, may actuate the link members (303) to angularly displace each of the pair of arms (104) away from each other i.e. diverging each of the pair of arms (104), and thus adjusting the pair of arms (104) based on the geometry of the structure to facilitate docking the aerial vehicle (200).

In some embodiments, the arm mechanism (100) may include a pulley arrangement, a wire or a rope arrangement, a hydraulic actuation arrangement, pneumatic actuation arrangement and the like, without deviating from scope of the present disclosure, to angularly displace each of the pair of arms (104) for docking the aerial vehicle (200) to different geometrical structures.

In an embodiment, the arm mechanism (100) and the testing probe (204) may be enclosed within a housing, made of thermally insulative material, to withstand high operational temperature of about 200 to 250 degrees and external environmental forces. As an example, the thermally insulative material may be one of but not limiting to ceramic and carbon material.

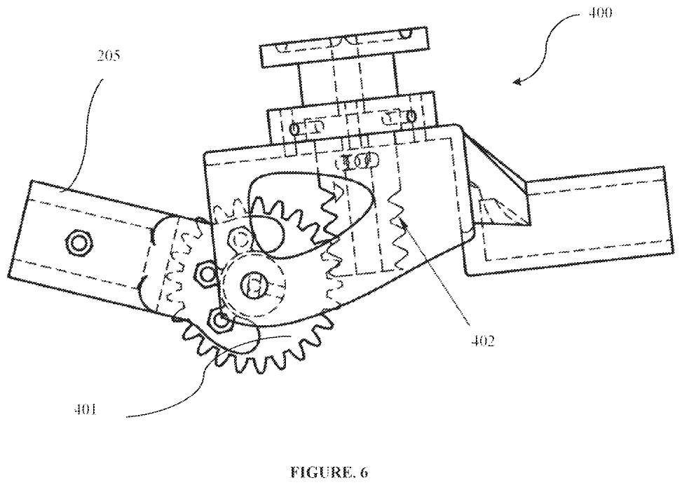

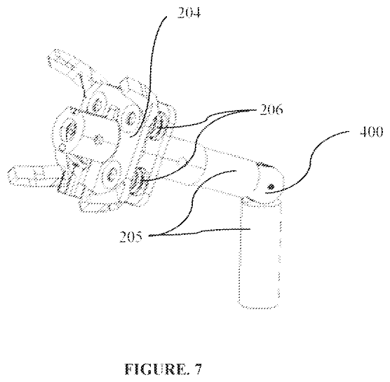

Returning back to FIG. 1, the support structure (203), which is adapted to position the testing probe (204) may be configured with an adjustment mechanism (400), to angularly displace the testing probe (204) based on the geometry of the structure, in order to facilitate firm contact of the testing probe (204), irrespective of irregularities on the surface of the structure. As seen in FIG. 6, the adjustment mechanism (400) in the support structure (203) may include a spur gear (401) and a worm gear (402) arrangement. The worm gear (402) is adapted to be actuated by the user. As an example, the required actuation of the adjustment mechanism (400) is pre-determined, then the user actuates (i.e. rotates) the worm gear (402), which in turns rotate the spur gear (401). Rotation of the spur gear (401) may result in displacing the probe holder (205), in order to adjust the testing probe (204) to contact with different geometrical structure. As apparent from FIG. 7, an end of the probe holder (205) extending from the support structure (203), may comprise a damper (206). The damper (206) may be configured to facilitate in manipulating the testing probe (204) in various degrees of freedom. This facilitates in providing flexibility for the testing probe (204) to adjust for contacting itself on the uneven geometries of the structure.

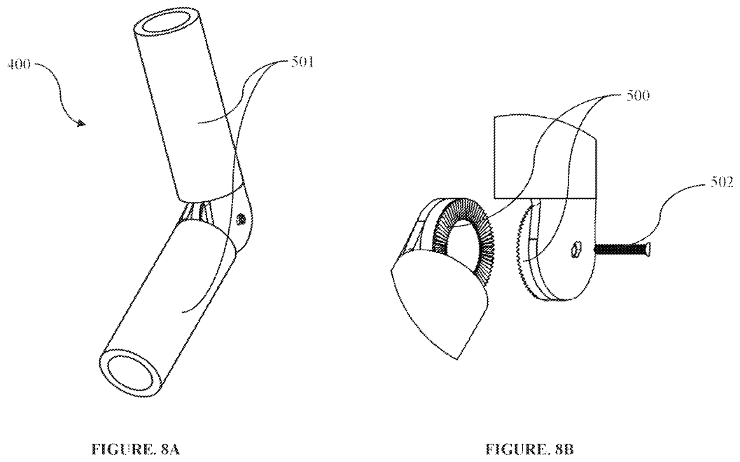

In an embodiment, the adjustment mechanism (400) to adjust (i.e. angularly displace) the probe holder (205) (thus, the testing probe (204)), may include rosette gears (500). As apparent from FIG. 8A, the probe holder (205) may be divided into two sections (501), with the rosette gears (500) positioned at an end of each of the sections (501) of the probe holder (205) [best seen in FIG. 8B]. The rosette gears (500) at an end of each of the sections (501) of the probe holder (205), may be engaged and secured by a fastening element (502), such as but not limiting to a screw, a nut and bolt arrangement and the like. As an example, in order to adjust the testing probe (204) based on the requirement, the fastening element (502) may be disengaged, and the sections (501) of the probe holder (205) may be operated based on the requirement and the sections (501) may be secured by the fastening element (502). Thus, the adjustment mechanism (400) facilitates in adjusting position of the testing probe (204), as per requirement.

In an embodiment, the probe holder (205) may be configured to be telescopic. This facilitates the probe holder (205) to extend or retract, based on angular displacement of the arms (104), in order to contact the testing probe (204) with the surface of the structure.

In an embodiment, the unmanned aerial vehicle (200) comprises at least one sensor, associated with the testing probe (204). The at least one sensor may be configured to determine contact of the testing probe (204) with the structure, during non-destructive testing. As an example, the at least one sensor may be a force sensor. This facilitates the user to determine contact of the testing probe (204) during non-destructive testing and hence, may facilitate in obtaining accurate readings, which in turn aids in assessing parameters of the structure precisely.

In an embodiment, the arm mechanism (100) may facilitate in adapting a single unmanned aerial vehicle to conduct non-destructive testing of different types of structures having varied geometries.

### Equivalents

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Arm mechanism |
| 101 | Bracket |
| M | Pair of members |
| 102 | Gears |
| D | Driving unit |
| 103 | Worm gear |
| 104 | Arm |
| 105 | Pad |
| 106 | Wheel |
| 200 | Unmanned aerial vehicle |
| 201 | Body |
| 202 | Plurality of rotors |
| 203 | Support structure |
| 204 | Testing probe |
| 205 | Probe holder |
| 206 | Damper |
| 301 | Coupler units |
| 303 | Link members |
| 304 | Sleeve member |
| 305 | Collar |
| 400 | Adjustment mechanism |
| 401 | Spur gear |
| 402 | Worm gear |
| 500 | Rosette gears |
| 501 | Sections of the probe holder |
| 502 | Fastening element |

We claim:

1. An arm mechanism (100) for docking an unmanned aerial vehicle (200) to a structure for conducting non-destructive testing, the arm mechanism (100) comprising:
a bracket (101), connectable to a body (201) of the unmanned aerial vehicle (200);
a pair of members (M) rotatably positioned in the bracket (101), wherein each of the pair of members (M) is configured to rotate relative to movement of a driving unit (D); and
at least one arm (104), coupled to each of the pair of members (M);
wherein, actuation of the driving unit (D), drives each of the pair of members (M) to angularly displace each of the at least one arm (104), to facilitate adjustment of the arms (104) for docking the unmanned aerial vehicle (200) to the structure for non-destructive testing.

2. The arm mechanism (100) as claimed in claim 1, wherein each of the pair of members (M) is a gear (102).

3. The arm mechanism (100) as claimed in claim 2, wherein the gear (102) is a spur gear.

4. The arm mechanism (100) as claimed in claim 1, wherein the driving unit (D) is a worm gear (103) and is positioned in meshing engagement between the pair of gears (102).

5. The arm mechanism (100) as claimed in claim 1, wherein the angular displacement of each of the at least one arm (104), facilitates in docking the unmanned aerial vehicle (200) to different geometries of the structure.

6. The arm mechanism (100) as claimed in claim 1, the driving unit (D) is actuatable by a flange shaft, wherein the flange shaft is removably connectable to the driving unit (D).

7. The arm mechanism (100) as claimed in claim 1, comprises a rubber pad (105) coupled to an end of each of the at least one arm (104) via a torsional spring, wherein the rubber pad (105) provides traction for docking the unmanned aerial vehicle (200).

8. The arm mechanism (100) as claimed in claim 1, comprises a wheel (106) coupled to the end of each of the at least one arm (104), wherein the wheel (106) facilitates in docking and linear travel of the unmanned aerial vehicle (200).

9. The arm mechanism (100) as claimed in claim 1, wherein the arm mechanism (100) is enclosed in a housing made of thermally insulative material.

10. The arm mechanism (100) as claimed in claim 9, wherein the thermally insulative material is at least one of a ceramic and a carbon material.

11. The arm mechanism (100) as claimed in claim 1, wherein each of the pair of members (M) is a coupler unit (301).

12. The arm mechanism (100) as claimed in claim 1, wherein the driving unit (D) is a collar (305), configured to displace on a sleeve member (304).

13. The arm mechanism (100) as claimed in claim 11, comprises a pair of link members (303), wherein each of the pair of link members (303) are configured to connect the driving unit (D) and each of the pair of arms (104).

14. An unmanned aerial vehicle (200), adapted for conducting non-destructive testing, the aerial vehicle comprising:
a body (201);
a plurality of rotors (202) supported by the body (201), wherein the plurality of rotors (202) is adapted to exert a propulsion force to the unmanned aerial vehicle (200);
a support structure (203) connected to the body (201), wherein the support structure (203) is configured to position a testing probe (204);
an arm mechanism (100), for docking the unmanned aerial vehicle (200) to a structure, the mechanism (100) comprising:
a bracket (101), connectable to a body (201) of unmanned aerial vehicle (200);
a pair of members (M) rotatably positioned in the bracket (101), wherein each of the pair of members (M) are configured to rotate relative to movement of a driving unit (D); and
at least one arm (104), coupled to each of the pair of (102);
wherein, actuation of the driving unit (D), drives each of the pair of members (M) to angularly displace each of the at least one arm (104), to facilitate adjustment of the arms (104) for docking the unmanned aerial vehicle (200) to the structure for non-destructive testing.

15. The unmanned aerial vehicle (200) as claimed in claim 14, center of gravity of the unmanned aerial vehicle (200) is between a center of geometry of the body (201) and the testing probe (204), to facilitate in docking the unmanned aerial vehicle (200) to the structure.

16. The unmanned aerial vehicle (200) as claimed in claim 14, wherein the support structure (203) includes a telescopic probe holder (205), configured to adjust the testing probe (204) based on angular displacement of each of the at least one arms (104).

17. The unmanned aerial vehicle (200) as claimed in claim 14, wherein the support structure (203) of the testing probe (204) comprises an adjustment mechanism (400) to angularly displace the testing probe (204).

18. The unmanned aerial vehicle (200) as claimed in claim 17, wherein the adjustment mechanism (400) includes a spur gear (401) and a worm gear (402) arrangement, to angularly displace the testing probe (204).

19. The unmanned aerial vehicle (200) as claimed in claim 14, comprises a damper (206) configured at an end of the support structure (203), wherein the damper (206) facilitates in providing three degrees of freedom to adjust the probe (204) to dock on to the structure.

20. The unmanned aerial vehicle (200) as claimed in claim 14, wherein the testing probe (204) is an ultrasonic probe (204), and is encased with a ceramic material.

21. The unmanned aerial vehicle (200) as claimed in claim 14, comprises at least one sensor associated with the testing probe (204), wherein the at least one sensor is configured to determine contact of the testing probe (204) with a surface of the structure.

22. The unmanned aerial vehicle (200) as claimed in claim 21, wherein the at least one sensor is a force sensor.
